(19) United States
(12) Patent Application Publication
(10) Pub. No.: US 2014/0071710 A1
(43) Pub. Date: Mar. 13, 2014

(54) Graphic Frame for LED Light Boxes

(71) Applicants: Richard Schattinger, New York, NY (US); Derek J. Gabriels, Bay shore, NY (US)

(72) Inventors: Richard Schattinger, New York, NY (US); Derek J. Gabriels, Bay shore, NY (US)

(21) Appl. No.: 13/607,683

(22) Filed: Sep. 8, 2012

(51) Int. Cl. G09F 13/04

(52) U.S. Cl. 362/612

(57) ABSTRACT

A LED illuminated system to illuminate a graphic panel may include a front frame, a spacer device to be connected to the front frame, a LED edge-lit panel to form a cavity by a connection to the spacer device for the graphic panel to be nondestructively removed and replaced and a LED array connected to a back surface of the LED edge-lit panel to illuminate the graphic panel.

### FIELD OF THE INVENTION

This invention is directed to an edge-lit backlighting and strip light system for light emitting diode displays, and, more particularly, to a strip light system employing a number of light strips in the form of thin, light weight sections of a substrate each of which mounts a plurality of light engines having an array of densely packed, primary color light emitting diodes (“LEDs”).

### BACKGROUND

In recent years, there have been developed light-emitting diodes capable of emitting red, green, and blue colors (hereinafter referred to as “RGB” in some cases) and light-emitting diodes which are formed of light emitting elements in combination with phosphor materials so that they emit various colors, such as a white color, with a high brightness. Since a light-emitting diode (hereinafter referred to as an “LED”) is a solid-state element, it has superior resistance against vibration, a low-power consumption rate, a long operating life, and superior drive properties such as a high-speed drive. Accordingly, the light-emitting diodes have been increasingly used for various applications such as light sources for signal heads and full-color LED displays.

Light-emitting diode devices having various sizes and display effects have been developed and are available in the market. Depending on the complexity of required illumination pattern, most of the light-emitting diode devices include arrays of light-emitting diodes selectively switched on/off to generate such illumination pattern. When a complex illumination pattern is desired, the number of required light-emitting diodes can be significant. In addition, when the light-emitting diode devices are applied to an educational toy, the educational value is limited to the image only.

The light emitting diode devices may suffer from hot spots which may result in some of the light emitting diodes providing more light than others. This may result in an uneven lighting effect which may be cosmetic undesirable.

### SUMMARY

A LED illuminated system to illuminate a graphic panel may include a front frame, a spacer device to be connected to the front frame, a LED edge-lit panel to form a cavity by a connection to the spacer device for the graphic panel to be nondestructively removed and replaced and a LED array connected to a back surface of the LED edge-lit panel to illuminate the graphic panel.

The spacer device may be substantially U-shaped.

The graphic panel may be removed from the top of the LED illuminated system.

The graphic panel may be removed from the side of the LED illuminated system.

The LED illuminated system may include a plurality of graphic panels.

The LED illuminated system may include a single graphic panel.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front frame of the LED illuminated system of the present invention;

FIG. 2 illustrates a LED edge-lit panel of the LED illuminated system of the present invention;

FIG. 3 illustrates a perspective view of the front frame of the LED illuminated system and the spacer device of the LED illuminated system of the present invention;

FIG. 4 illustrates a back view of the front frame of the LED illuminated system and the spacer device of the LED illuminated system of the present invention;

FIG. 5 illustrates a perspective view of the front frame with spacer device, the LED edge-lit panel and graphic of the LED illuminated system of the present invention;

FIG. 6 illustrates a perspective view of the front frame with spacer device, graphic and LED edge-lit panel of the present invention;

FIG. 7 illustrates a side view of the front frame with the spacer device and LED edge-lit panel of the present invention;

FIG. 8 illustrates a sectional view of the front frame with the spacer device of the present invention;

FIG. 9 illustrates a perspective view of the LED illumination system of the present invention;

FIG. 10 illustrates a perspective view of another embodiment of the LED illumination system of the present invention;

FIG. 11 illustrates an exploded view of another embodiment of the LED illumination system of the present invention;

FIG. 12 illustrates a sectional view of another embodiment of the front frame with spacer device of the present invention;

FIGS. 13-16 illustrates a perspective view of the LED illumination system of the present invention.

### DETAILED DESCRIPTION

The LED illuminated system 100 of the present invention may provide and LED edge lit panel which may include an LED array or LED modules which may be positioned along a single edge of a graphic frame (the LED edge-lit panel 102) to hold a graphic panel 500 while hiding the LED array which may be a strip of at least two LED lights. The graphic panel 500 may be nondestructive removable by sliding in and out and can be sized to accommodate different thicknesses of the graphic panel 500. The graphic frame or LED edge-lit panel 102 may include a standoff which may be a spacer device 140 which may be U-shaped. The graphic frame or LED edge-lit panel 102 may be opaque to hide from sight the LED array and maybe rectangular, square, circular and may include a single graphic panel or may include a multitude of graphic panels. The graphic panel 500 may have cut outs for indicia, logos, lettering and numbering that can be illuminated.

The front frame 103 as shown in FIG. 2 may include a front first surface 111 which may be opposed to a back first surface 113 and may be connected to a pair of opposing side first surfaces 109, a top first surface 105 and a bottom first surface 107, the top first surface 105 may be connected to the pair of opposing side first surfaces 109, the front first surface 111, and the back first surface 113, the bottom first surface 107 may be connected to the pair of opposing side first surfaces 109, the front first surface 111 and the back first surface 113, the back front surface 113 may be connected to the top first surface 105, the bottom first surface 107, and the side first surface 109, and the pair of side first surfaces 109 may be connected to the top first surface 105, the bottom first surface 107, front first surface 111 and the back first surface 103.

The front frame 103 additionally includes a first top internal surface 102 which may be connected to the first front surface 111 and the first back surface 113 and which may be connected to a pair of first side internal surfaces 106. The first side internal surface 106 may be connected to the first front surface 111 and the first back surface 113 and may be connected to the first top internal surface 102 and the first bottom internal surface 104. The first bottom internal surface 104 may be connected to the first side internal surfaces 106 and may be connected to the first front surface 111 and the first back surface 113.

The first top internal surface 102 the first bottom internal surface 104 and the first side internal surface 106 may define a cavity 108.

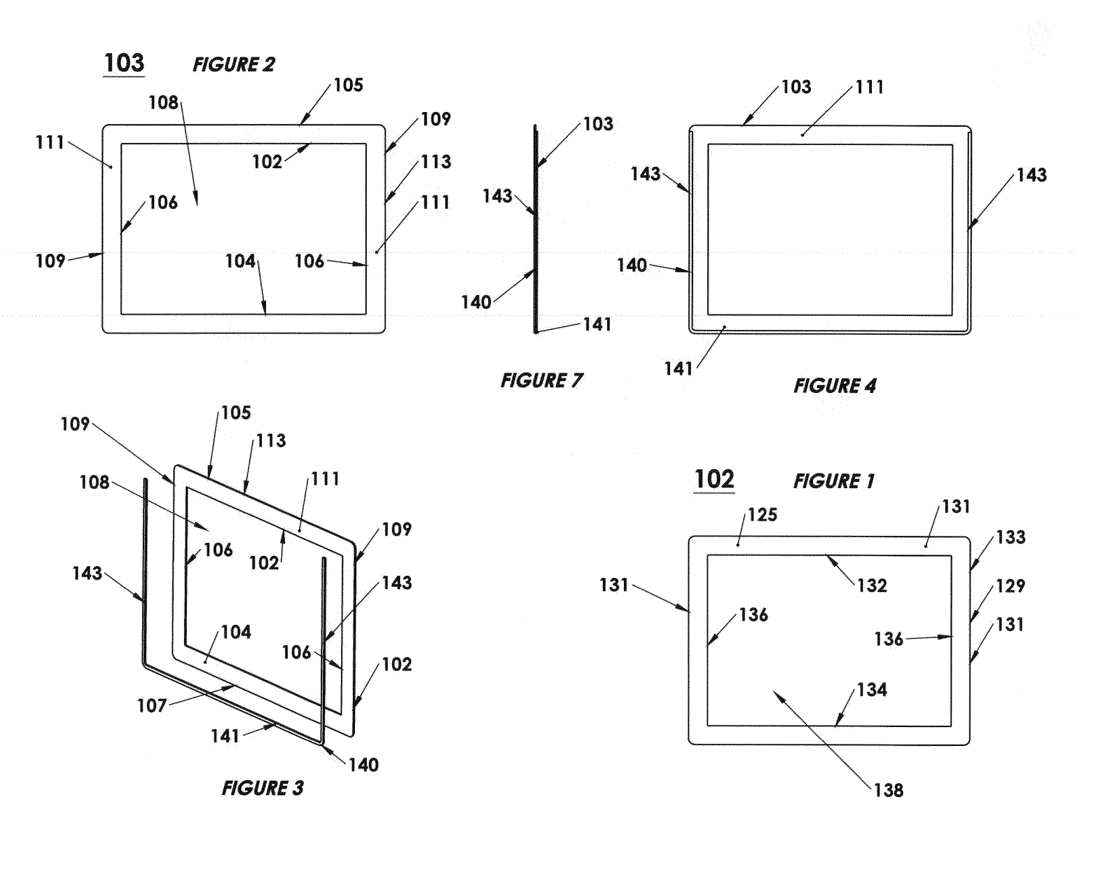

The LED edge-lit panel 102 as shown in FIG. 1 may include a front second surface 131 which may be opposed to a back second surface 133 and may be connected to a pair of opposing side second surfaces 129, a top second surface 125 and a bottom second surface 127, the top second surface 125 may be connected to the pair of opposing side second surfaces 129, the front second surface 131, and the back second surface 133, the bottom second surface 127 may be connected to the pair of opposing side second surfaces 129, the front second surface 131 and the back second surface 133, the back second surface 133 may be connected to the top second surface 125, the bottom second surface 127, and the side second surface 129, and the pair of side second surfaces 129 may be connected to the top second surface 125, the bottom second surface 127, front second surface 131 and the back second surface 133.

The LED edge-lit panel 102 additionally includes a second top internal surface 132 which may be connected to the second front surface 131 and the second back surface 133 and which may be connected to a pair of second side internal surfaces 136. The second side internal surface 136 may be connected to the second front surface 131 and the second back surface 133 and may be connected to the second top internal surface 132 and the second bottom internal surface 134. The second bottom internal surface 134 may be connected to the second side internal surfaces 136 and may be connected to the second front surface 131 and the second back surface 133.

The second top internal surface 132 the second bottom internal surface 134 and the second side internal surface 136 may define a cavity 138.

FIG. 3 illustrates an exploded view of the front frame 103 and the U-shaped spacer device 140 which may be connected to the front frame 103 by adhesive, welding or other attachment devices and which may be connected to the LED edge-lit panel 102 by adhesive, welding or other attachment devices. The front frame 103 as shown in FIG. 3 may include a front first surface 111 which may be opposed to a back first surface 113 and may be connected to a pair of opposing side first surfaces 109, a top first surface 105 and a bottom first surface 107, the top first surface 105 may be connected to the pair of opposing side first surfaces 109, the front first surface 111, and the back first surface 113, the bottom first surface 107 may be connected to the pair of opposing side first surfaces 109, the front first surface 111 and the back first surface 113, the back front surface 113 may be connected to the top first surface 105, the bottom first surface 107, and the side first surface 109, and the pair of side first surfaces 109 may be connected to the top first surface 105, the bottom first surface 107, front first surface 111 and the back first surface 103.

The front frame 103 additionally includes a first top internal surface 102 which may be connected to the first front surface 111 and the first back surface 113 and which may be connected to a pair of first side internal surfaces 106. The first side internal surface 106 may be connected to the first front surface 111 and the first back surface 113 and may be connected to the first top internal surface 102 and the first bottom internal surface 104. The first bottom internal surface 104 may be connected to the first side internal surfaces 106 and may be connected to the first front surface 111 and the first back surface 113.

The first top internal surface 102 the first bottom internal surface 104 and the first side internal surface 106 may define a cavity 108.

The U-shaped spacer device 140 as shown in FIG. 3 may include a rectangular cross-section and may be substantially solid and may be formed from metal, plastic or other appropriate material.

The front frame 103 and the LED edge-lit panel 102 may include a rectangular cross-section and may be substantially solid and may be formed from metal, plastic or other appropriate material.

The U-shaped spacer device 140 may include a base spacer member 141 which may be connected to an opposing pair of upward extending spacer members 143. The U-shaped spacer device 140 may be connected to the first back surface 113 of the front frame 103.

FIG. 4 illustrates the U-shaped spacer device 140 which may include the base spacer member 141 and the pair of upward extending spacer members 143 and which may be connected to the first back surface 113 of the front frame 103.

FIG. 7 illustrates a side view of the U-shaped spacer device 140 and illustrates the upward extending spacer member 143 and the base spacer member 141 may be connected to the front frame 103.

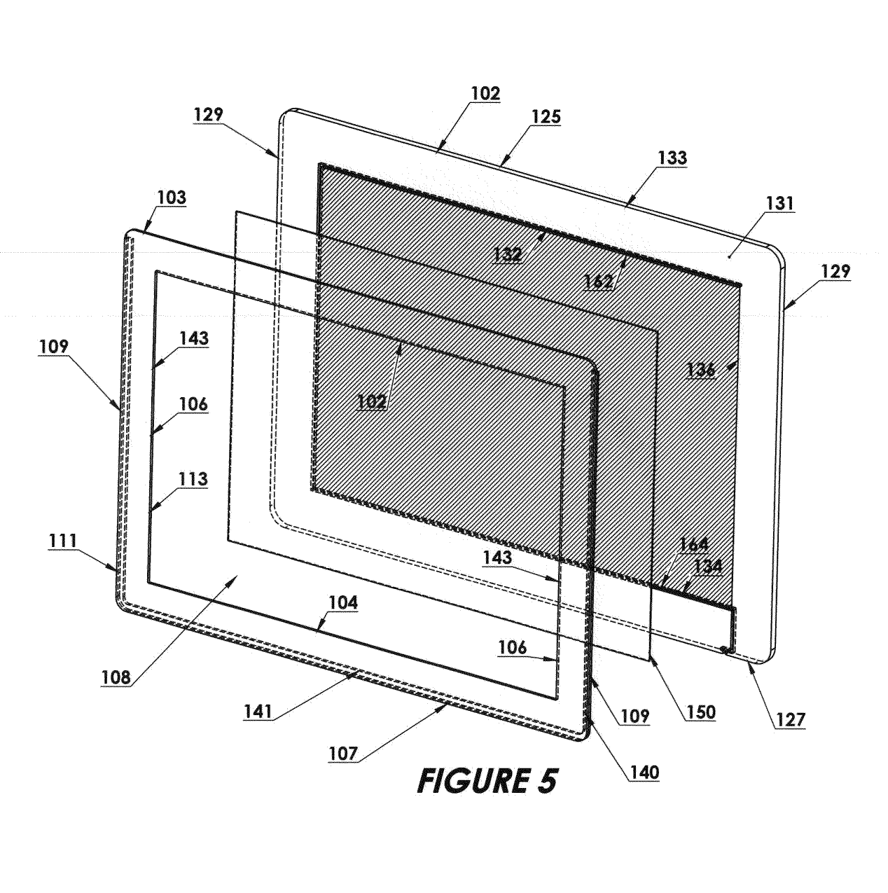

FIG. 5 illustrates an exploded view of the front frame 103 including the spacer device 140, the LED edge-lit panel 102 and the graphic panel 500 which may be sandwiched between the front frame 103 and the spacer device 140 and the LED edge-lit panel 102.

The LED edge-lit panel 102 as shown in FIG. 5 may include a front second surface 131 which may be opposed to a back second surface 133 and may be connected to a pair of opposing side second surfaces 129, a top second surface 125 and a bottom second surface 127, the top second surface 125 may be connected to the pair of opposing side second surfaces 129, the front second surface 131, and the back second surface 133, the bottom second surface 127 may be connected to the pair of opposing side second surfaces 129, the front second surface 131 and the back second surface 133, the back second surface 133 may be connected to the top second surface 125, the bottom second surface 127, and the side second surface 129, and the pair of side second surfaces 129 may be connected to the top second surface 125, the bottom second surface 127, front second surface 131 and the back second surface 133.

The LED edge-lit panel 102 additionally includes a second top internal surface 132 which may be connected to the second front surface 131 and the second back surface 133 and which may be connected to a pair of second side internal surfaces 136. The second side internal surface 136 may be connected to the second front surface 131 and the second back surface 133 and may be connected to the second top internal surface 132 and the second bottom internal surface 134. The second bottom internal surface 134 may be connected to the second side internal surfaces 136 and may be connected to the second front surface 131 and the second back surface 133.

The second top internal surface 132 the second bottom internal surface 134 and the second side internal surface 136 may define a cavity 138.

The second top internal surface 132 may be adjacent to a first LED array (module) 162 which may include a first strip of LED lights, and the second bottom internal surface 134 may be adjacent to a second LED array (module) 164 which may include a second strip of LED lights. The LED lights may be positioned adjacent to the second side internal surface 134 (not shown).

FIG. 5 illustrates an exploded view of the front frame 103 and the U-shaped spacer device 140. The front frame 103 as shown in FIG. 5 may include a front first surface 111 which may be opposed to a back first surface 113 and may be connected to a pair of opposing side first surfaces 109, a top first surface 105 and a bottom first surface 107, the top first surface 105 may be connected to the pair of opposing side first surfaces 109, the front first surface 111, and the back first surface 113, the bottom first surface 107 may be connected to the pair of opposing side first surfaces 109, the front first surface 111 and the back first surface 113, the back front surface 113 may be connected to the top first surface 105, the bottom first surface 107, and the side first surface 109, and the pair of side first surfaces 109 may be connected to the top first surface 105, the bottom first surface 107, front first surface 111 and the back first surface 103.

The front frame 103 additionally includes a first top internal surface 102 which may be connected to the first front surface 111 and the first back surface 113 and which may be connected to a pair of first side internal surfaces 106. The first side internal surface 106 may be connected to the first front surface 111 and the first back surface 113 and may be connected to the first top internal surface 102 and the first bottom internal surface 104. The first bottom internal surface 104 may be connected to the first side internal surfaces 106 and may be connected to the first front surface 111 and the first back surface 113.

The first top internal surface 102 the first bottom internal surface 104 and the first side internal surface 106 may define a cavity 108.

The U-shaped spacer device 140 as shown in FIG. 5 may include a rectangular cross-section and may be substantially solid and may be formed from metal, plastic or other appropriate material.

The front frame 103 and the LED edge-lit panel 102 may include a rectangular cross-section and may be substantially solid and may be formed from metal, plastic or other appropriate material.

The U-shaped spacer device 140 may include a base spacer member 141 which may be connected to an opposing pair of upward extending spacer members 143. The U-shaped spacer device 140 may be connected to the first back surface 113 of the front frame 103.

FIG. 5 illustrates an exploded view of the front frame 103 including the spacer device 140, the LED edge-lit panel 102 and the graphic panel which may be sandwiched between the front frame 103 and the spacer device 140 and the LED edge-lit panel 102.

The LED edge-lit panel 102 as shown in FIG. 5 may include a front second surface 131 which may be opposed to a back second surface 133 and may be connected to a pair of opposing side second surfaces 129, a top second surface 125 and a bottom second surface 127, the top second surface 125 may be connected to the pair of opposing side second surfaces 129, the front second surface 131, and the back second surface 133, the bottom second surface 127 may be connected to the pair of opposing side second surfaces 129, the front second surface 131 and the back second surface 133, the back second surface 133 may be connected to the top second surface 125, the bottom second surface 127, and the side second surface 129, and the pair of side second surfaces 129 may be connected to the top second surface 125, the bottom second surface 127, front second surface 131 and the back second surface 133.

The LED edge-lit panel 102 additionally includes a second top internal surface 132 which may be connected to the second front surface 131 and the second back surface 133 and which may be connected to a pair of second side internal surfaces 136. The second side internal surface 136 may be connected to the second front surface 131 and the second back surface 133 and may be connected to the second top internal surface 132 and the second bottom internal surface 134. The second bottom internal surface 134 may be connected to the second side internal surfaces 136 and may be connected to the second front surface 131 and the second back surface 133.

The second top internal surface 132 the second bottom internal surface 134 and the second side internal surface 136 may define a cavity 138.

The second top internal surface 132 may be adjacent to a first LED array (module) 162 which may include a first strip of LED lights, and the second bottom internal surface 134 may be adjacent to a second LED array (module) 164 which may include a second strip of LED lights. The LED lights may be positioned adjacent to the second side internal surface 134 (not shown).

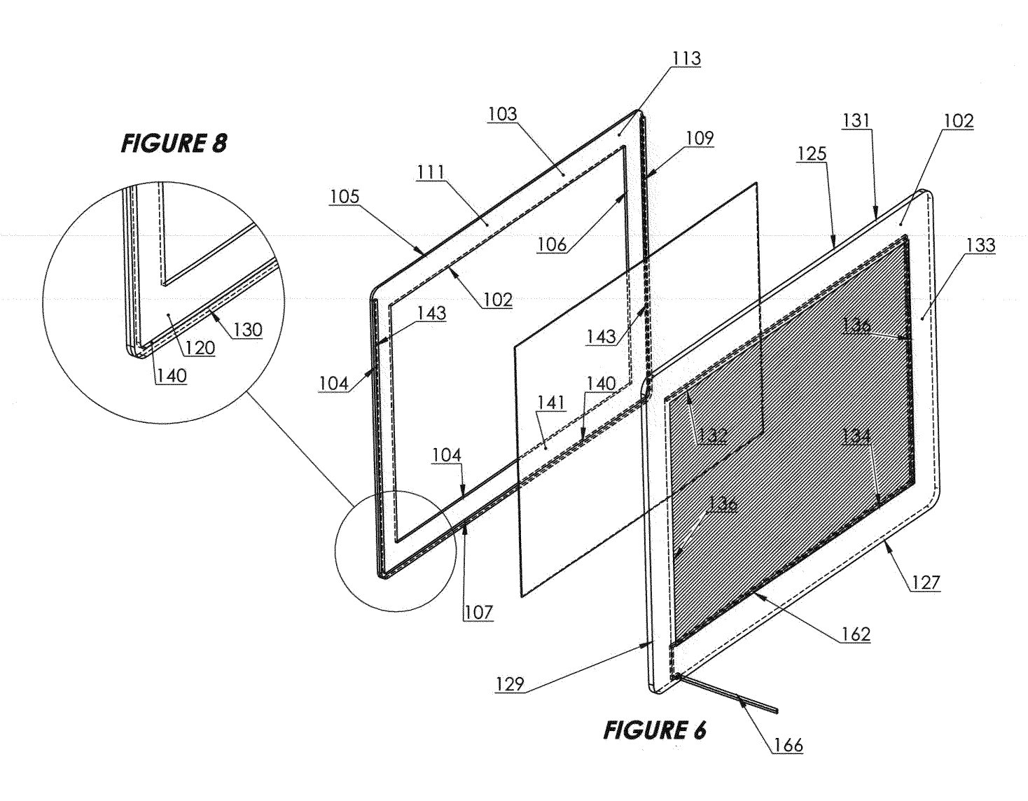

FIG. 6 illustrates a back exploded view of the front frame 103 and the U-shaped spacer device 140. The front frame 103 as shown in FIG. 6 may include a front first surface 111 which may be opposed to a back first surface 113 and may be connected to a pair of opposing side first surfaces 109, a top first surface 105 and a bottom first surface 107, the top first surface 105 may be connected to the pair of opposing side first surfaces 109, the front first surface 111, and the back first surface 113, the bottom first surface 107 may be connected to the pair of opposing side first surfaces 109, the front first surface 111 and the back first surface 113, the back front surface 113 may be connected to the top first surface 105, the bottom first surface 107, and the side first surface 109, and the pair of side first surfaces 109 may be connected to the top first surface 105, the bottom first surface 107, front first surface 111 and the back first surface 103.

The front frame 103 additionally includes a first top internal surface 102 which may be connected to the first front surface 111 and the first back surface 113 and which may be connected to a pair of first side internal surfaces 106. The first side internal surface 106 may be connected to the first front surface 111 and the first back surface 113 and may be connected to the first top internal surface 102 and the first bottom internal surface 104. The first bottom internal surface 104 may be connected to the first side internal surfaces 106 and may be connected to the first front surface 111 and the first back surface 113.

The first top internal surface 102 the first bottom internal surface 104 and the first side internal surface 106 may define a cavity 108.

The U-shaped spacer device 140 as shown in FIG. 6 may include a rectangular cross-section and may be substantially solid and may be formed from metal, plastic or other appropriate material.

The front frame 103 and the LED edge-lit panel 102 may include a rectangular cross-section and may be substantially solid and may be formed from metal, plastic or other appropriate material.

The U-shaped spacer device 140 may include a base spacer member 141 which may be connected to an opposing pair of upward extending spacer members 143. The U-shaped spacer device 140 may be connected to the first back surface 113 of the front frame 103.

The LED edge-lit panel 102 as shown in FIG. 6 may include a front second surface 131 which may be opposed to a back second surface 133 and may be connected to a pair of opposing side second surfaces 129, a top second surface 125 and a bottom second surface 127, the top second surface 125 may be connected to the pair of opposing side second surfaces 129, the front second surface 131, and the back second surface 133, the bottom second surface 127 may be connected to the pair of opposing side second surfaces 129, the front second surface 131 and the back second surface 133, the back second surface 133 may be connected to the top second surface 125, the bottom second surface 127, and the side second surface 129, and the pair of side second surfaces 129 may be connected to the top second surface 125, the bottom second surface 127, front second surface 131 and the back second surface 133.

The LED edge-lit panel 102 additionally includes a second top internal surface 132 which may be connected to the second front surface 131 and the second back surface 133 and which may be connected to a pair of second side internal surfaces 136. The second side internal surface 136 may be connected to the second front surface 131 and the second back surface 133 and may be connected to the second top internal surface 132 and the second bottom internal surface 134. The second bottom internal surface 134 may be connected to the second side internal surfaces 136 and may be connected to the second front surface 131 and the second back surface 133.

The second top internal surface 132 the second bottom internal surface 134 and the second side internal surface 136 may define a cavity 138.

The second top internal surface 132 may be adjacent to a first LED array (module) 162 which may include a first strip of LED lights, and the second bottom internal surface 134 may be adjacent to a second LED array (module) 164 which may include a second strip of LED lights. The LED lights may be positioned adjacent to the second side internal surface 134 (not shown). FIG. 6 additionally illustrates a power cord 166 to power the first LED array 162 and the second LED array 164.

FIG. 8 illustrates a sectional view of the LED edge-lit panel 102, the front frame 103 and the spacer device 140.

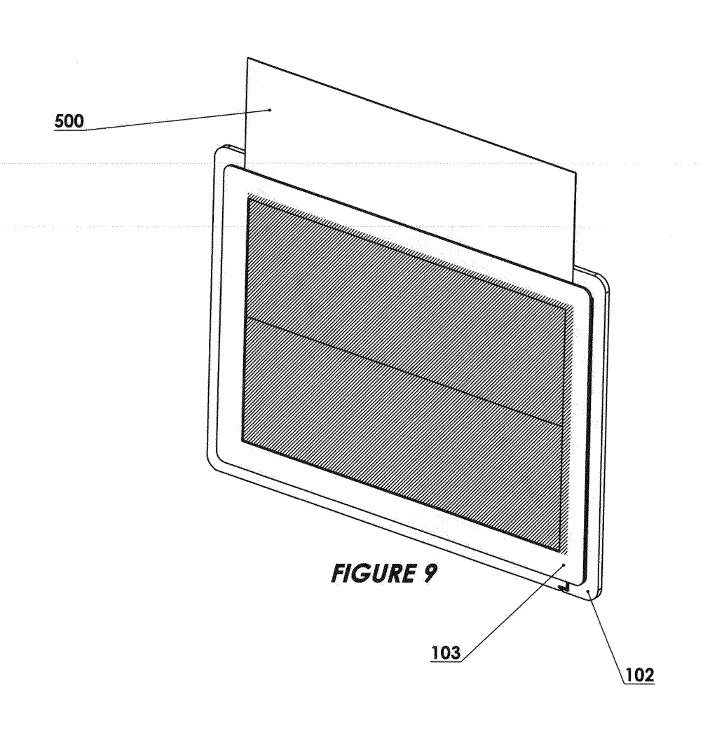

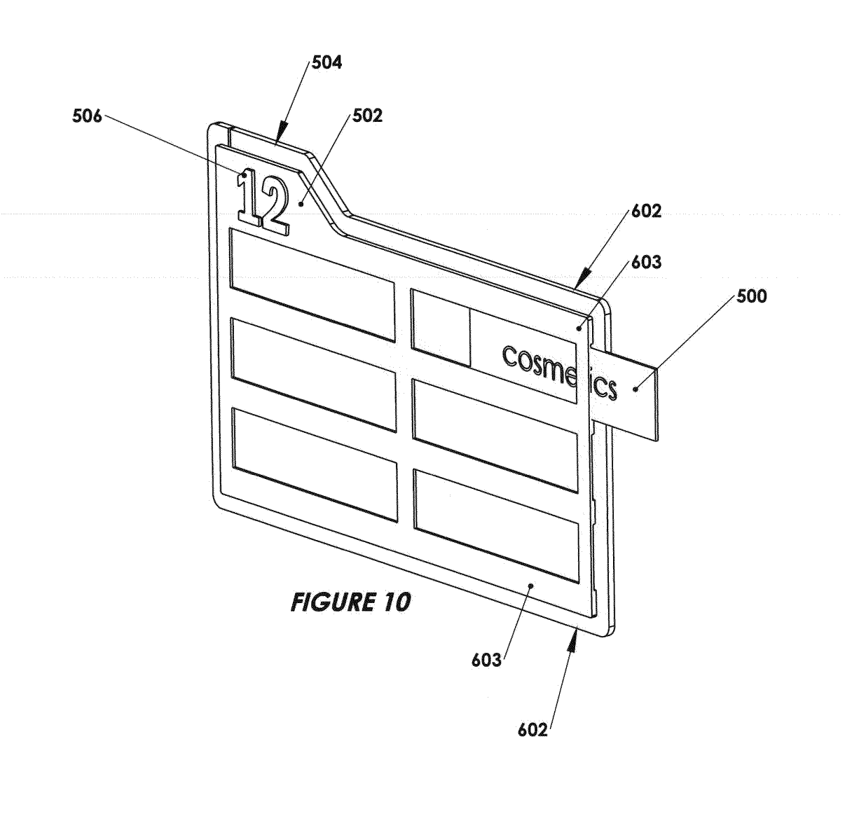

FIG. 9 illustrates the graphic panel 500 being removed/placed into the cavity between the front frame 103 and the LED edge-lit panel 102.

FIG. 10 illustrates the front frame 603 including multiple cavities so that multiple graphic panels 500 may be sandwiched between the front frame 603 and the LED edge-lit panel 602. Additionally, FIG. 10 illustrates that the front frame 603 includes a first tab 502 and the LED edge-lit panel 602 includes a second tab 504 to allow indicia 506 to be displayed.

FIG. 11 illustrates in an exploded view the front frame 603 including multiple cavities so that multiple graphic panels 500 may be sandwiched between the front frame 603 and the LED edge-lit panel 602. Additionally, FIG. 11 illustrates that the front frame 603 sets includes a first tab 502 and the LED edge-lit panel 602 includes a second tab 504 to allow indicia 506 to be displayed.

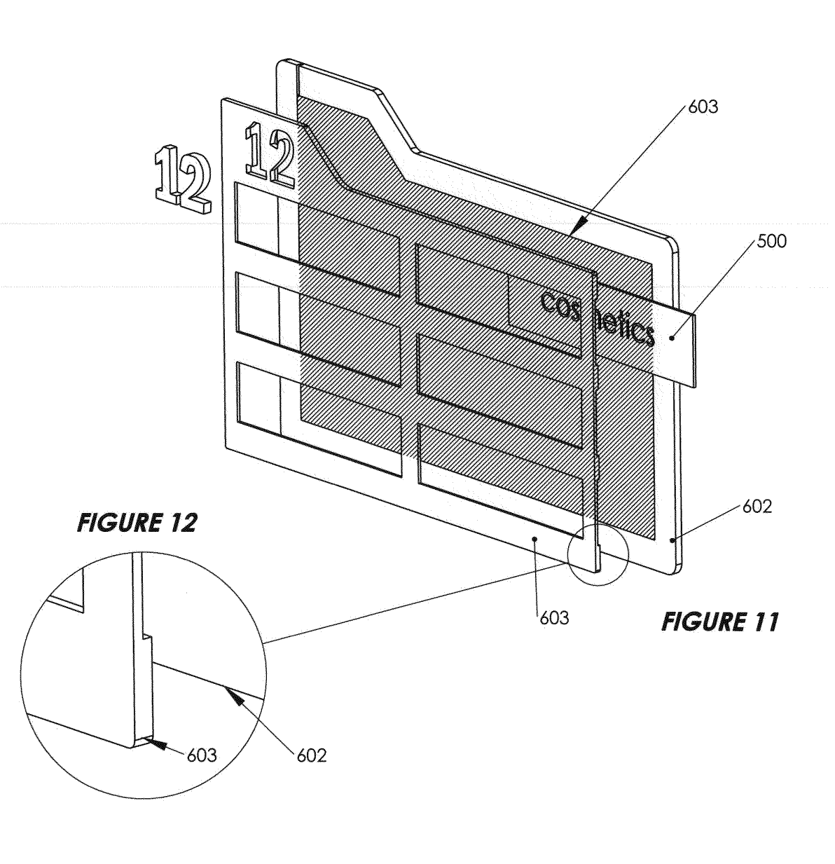

FIG. 12 illustrates a sectional view of the LED illuminated system of the present invention.

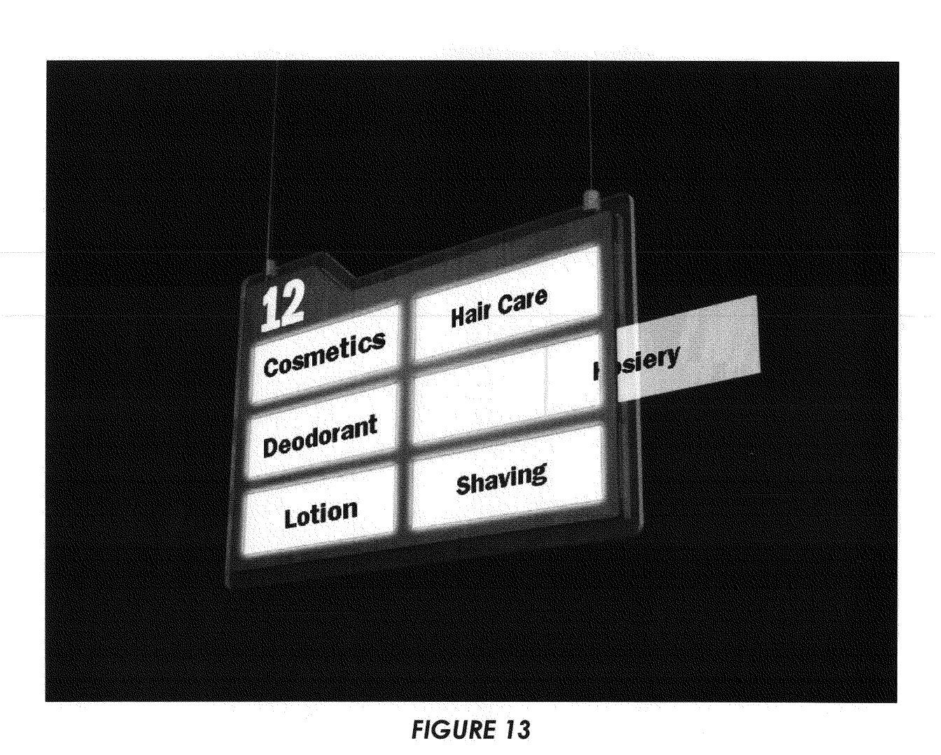

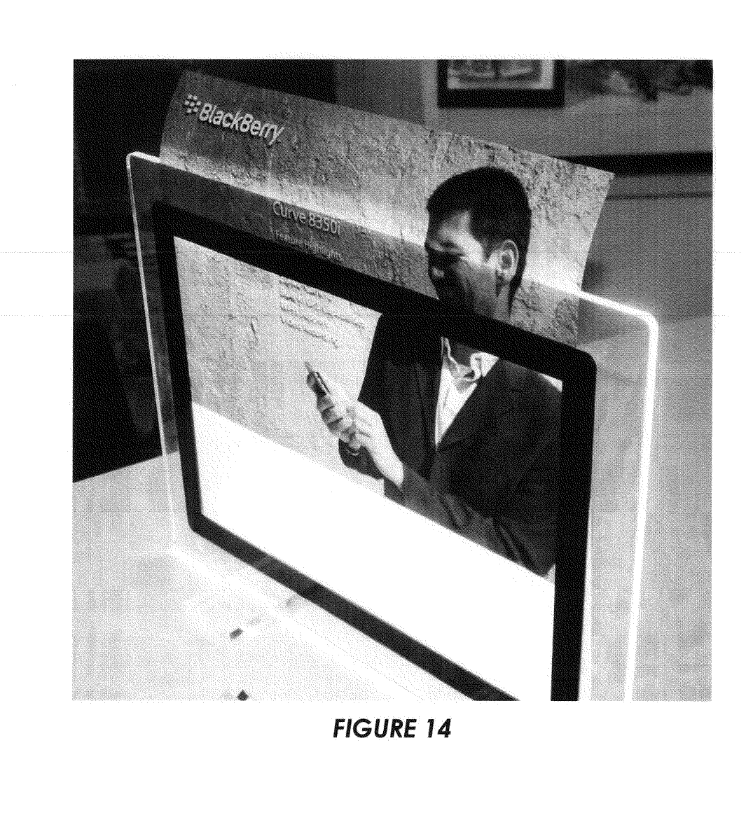

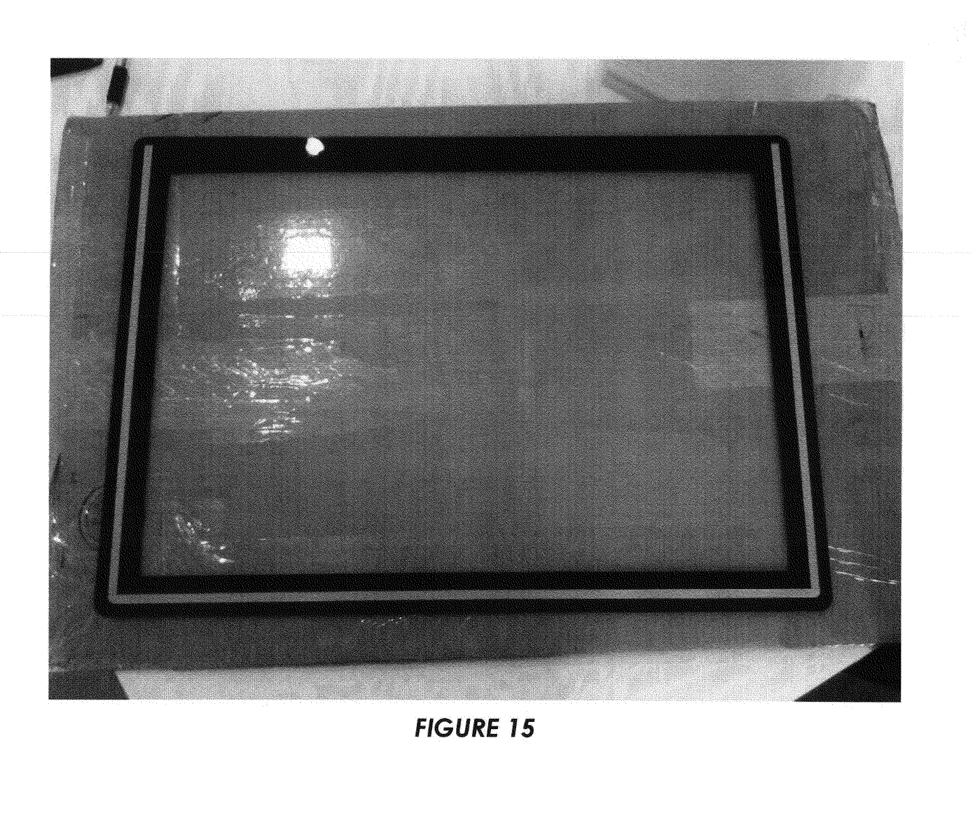

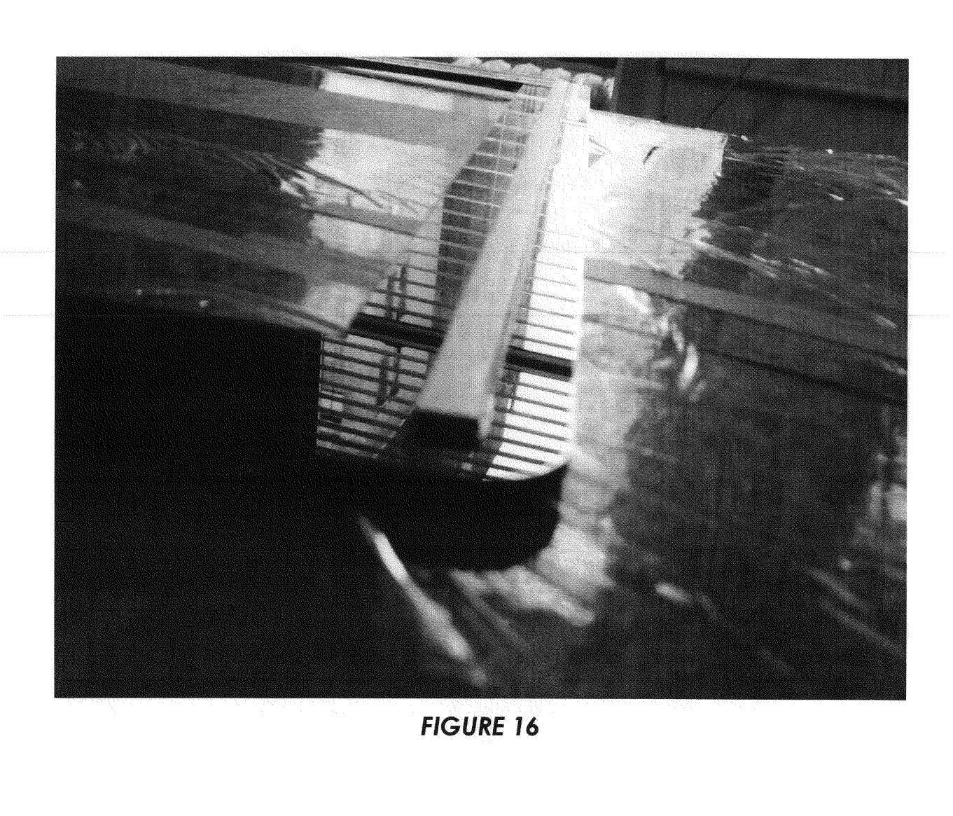

FIGS. 13-15 illustrates a perspective view of the LED illuminated system of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A LED illuminated system to illuminate a graphic panel, comprising:
a front frame;
a spacer device to be connected to the front frame;
a LED edge-lit panel to form a cavity by a connection to the spacer device for the graphic panel to be nondestructively removed and replaced from the cavity defined by the LED edge-lit panel and the front frame; and
a LED array connected to a back surface of the LED edge-lit panel to illuminate the graphic panel.

2. A LED illuminated system to illuminate a graphic panel as in claim 1, wherein the spacer device is substantially U-shaped.

3. A LED illuminated system to illuminate a graphic panel as in claim 1, wherein the graphic panel is removed from the top of the LED illuminated system.

4. A LED illuminated system to illuminate a graphic panel as in claim 1, wherein the graphic panel is removed from the side of the LED illuminated system.

5. A LED illuminated system to illuminate a graphic panel as in claim 1, wherein the LED illuminated system includes a plurality of graphic panels.

6. A LED illuminated system to illuminate a graphic panel as in claim 1, wherein the LED illuminated system includes a single graphic panel.
